(19) United States
(12) Patent Application Publication
(10) Pub. No.: US 2025/0245989 A1
(43) Pub. Date: Jul. 31, 2025

(54) CAMERA

(71) Applicant: Alarm.com Incorporated, Tysons, VA (US)

(72) Inventor: Yang Yang Zheng, Richmond, VA (US)

(21) Appl. No.: 18/973,228

(22) Filed: Dec. 9, 2024

Related U.S. Application Data
(60) Provisional application No. 63/626,604, filed on Jan. 30, 2024.

(51) Int. Cl. G06V 20/52; G06V 10/44

(52) U.S. Cl. CPC G06V 20/52; G06V 10/44; G06V 2201/07

(57) ABSTRACT

Methods, systems, and apparatus, including computer programs encoded on computer storage media, for camera image analysis. One of the methods includes: capturing, by a camera, a video sequence that depicts a property; while continuing to capture the video sequence: detecting, by the camera, a representation of an entity in the video sequence; and in response to detecting the representation of the entity in the video sequence, sending, to a video analysis system, a snapshot a) from the video sequence and b) that includes the representation of the entity; and after a threshold period of time from detection of the representation of the entity, sending, to the video analysis system, at least a portion of the video sequence.

### CROSS-REFERENCE TO RELATED APPLICATION

This application claims the benefit of U.S. Provisional Application No. 63/626,604, filed Jan. 30, 2024, and titled “Improved Camera,” which is incorporated by reference.

### BACKGROUND

A property can be equipped with cameras to monitor activity within the property.

### SUMMARY

To avoid costs and computation, there is often a delay between recording a video by a camera at a property and uploading the video to a server or another backend system. After being uploaded to the server, the video can be analyzed to identify people and objects in the video. If a bad actor, however, damages a camera during the delay time period, the camera can be unable to upload the video, and the video cannot be analyzed, reducing security at the property.

The present disclosure provides systems and methods to enable a camera to provide information about a potential bad actor before the camera is potentially damaged. For example, the camera can be configured to send a snapshot when a person or another potential entity of interest is identified in a video sequence to the backend system, e.g., within a threshold period of time that is shorter than the delay time period. Then the backend system can check for receipt of a video sequence after a second threshold period of time from receiving snapshot. If the backend system does not receive the video sequence, indicating that the camera might be damaged, the backend system can check for connectivity with the camera. If the backend system cannot connect with the camera, the backend system can analyze the received snapshot. If the backend system can connect with the camera, the backend system can determine that the camera was not likely damaged and likely has an issue with transferring data, e.g., given network or other sources of issues.

In general, one innovative aspect of the subject matter described in this specification can be embodied in methods that include the actions of: capturing, by a camera, a video sequence that depicts a property; while continuing to capture the video sequence: detecting, by the camera, a representation of an entity in the video sequence; and in response to detecting the representation of the entity in the video sequence, sending, to a video analysis system, a snapshot a) from the video sequence and b) that includes the representation of the entity; and after a threshold period of time from detection of the representation of the entity, sending, to the video analysis system, at least a portion of the video sequence.

Another general aspect can be embodied in a method including the actions of: receiving, by a video analysis system, a snapshot captured by a camera and that includes a representation of an entity that indicates that the camera detected the entity at a property; after a threshold period of time from receipt of the snapshot, determining whether a backend system received, from the camera, a video sequence for the representation of the entity within the threshold period of time and that indicates that the camera was not likely damaged; and performing an action using a result of the determination whether the video sequence indicates that the camera was not likely damaged.

In some implementations, the camera sends the snapshot only in response to only detecting the representation of the entity.

In some implementations, the portion of the video sequence includes the snapshot.

In some implementations, sending the snapshot includes sending the snapshot within a time period from detecting the representation of the entity in the video sequence that is less than a delay time period of the camera for sending data.

In some implementations, a data size of the snapshot is less than a data size of the at least a portion of video sequence.

In some implementations, the method further includes: detecting that the entity is within a threshold distance of the property; and in response to detecting that the entity is within the threshold distance of the property, sending the at least a portion of the video sequence to the video analysis system.

In some implementations, the method further includes: detecting, within the representation of the entity, a predetermined feature; and in response to detecting the predetermined feature, sending the at least a portion of the video sequence to the video analysis system.

In some implementations, the method further includes sending, to a backend server in communication with the video analysis system, the snapshot.

In some implementations, performing the action includes, when the backend system has received the video sequence within the threshold period of time, deleting the snapshot.

In some implementations, performing the action includes, when the backend system has not received the video sequence within the threshold period of time, determining, by the video analysis system, whether the backend system can communicate with the camera.

In some implementations, the method further includes: determining, by the video analysis system, that the backend system cannot communicate with the camera; and in response to determining that the backend system cannot communicate with the camera, triggering an alarm for the property.

In some implementations, the method further includes: determining, by the video analysis system, that the backend system cannot communicate with the camera; and in response to determining that the backend system cannot communicate with the camera, sending a first signal to the camera.

In some implementations, performing the action includes: after a second threshold period of time from sending the first signal, determining whether the backend system has received a second signal from the camera; performing the action using a result of the determination whether the video analysis system has received the second signal from the camera within the second threshold period of time.

In some implementations, a data size of the snapshot is less than a data size of the at least a portion of video sequence.

In some implementations, the threshold period of time is longer than a delay time period of the camera for sending data.

In some implementations, performing an action using a result of the determination being that the video sequence indicates that the camera was likely damaged includes triggering an alarm for the property.

In some implementations, performing an action using a result of the determination being that the video sequence indicates that the camera was not likely damaged includes sending a notification to a user device on the property.

In some implementations, the method further includes determining the threshold period of time using data representing network conditions for the property.

In some implementations, the method further includes receiving from a backend system included in the video analysis system, a message indicating whether the backend system received the video sequence within the threshold period of time from receipt of the snapshot.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. In some implementations, sending a snapshot before uploading the video can provide information about a bad actor when no information would otherwise be available, e.g., when the camera is damaged. Waiting for the video sequence before checking for connectivity issues can reduce unnecessary processing, thereby reducing computational resource usage because the backend system will not check for connectivity issues when the backend system receives video. In some implementations, the backend system preemptively checks for connectivity issues with the camera when the backend system has not received the video after a threshold period of time can reduce the overall amount of time the camera is damaged without detection, e.g., and the bad actor remains on the property unnoticed.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an environment including a property and a video analysis system.

FIG. 2 is a flow diagram of a process for sending a video sequence to a video analysis system.

FIG. 3 is a flow diagram of a process for performing an action based on receipt of a video sequence within a threshold period of time.

FIG. 4 is a diagram illustrating an example of a home monitoring system.

Like reference numbers and designations in the various drawings indicate like elements.

### DETAILED DESCRIPTION

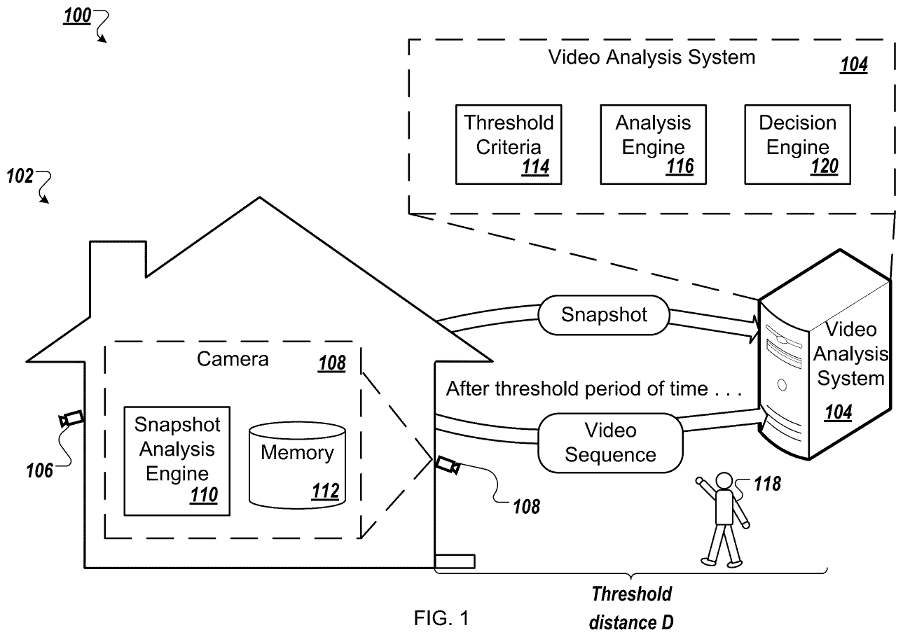

FIG. 1 depicts an environment 100 including a property 102 and a video analysis system 104. The video analysis system 104 can determine whether a camera 108 on the property 102 is likely damaged, as described in more detail below.

The property 102 can have one or more sensors 106, such as the camera 108, passive infrared (PIR) sensors, motion detectors, auditory sensors, wireless communication sensors, e.g., a device that can recognize a particular cell phone with Bluetooth, or a combination of two or more of these. The sensors 106 can be located at different locations within and outside of the property 102.

The camera 108 can be oriented and configured to detect objects at the property 102. For example, camera 108 can be configured to detect objects, e.g., entities, such as a person 118 or an animal, within a threshold distance D of the property 102. The camera can detect whether an object is within a threshold distance D of the property 102 by using video analytics for corroborating images captured by the camera. This can include corroborating the images with data collected by other sensors, e.g., a motion detector disposed at the threshold distance D, or other appropriate types of video analytics, including analysis of an image alone.

In some implementations, the camera 108 is configured to continuously record video footage, e.g., a sequence of images that defines a video sequence. In some implementations, the camera one is configured to begin recording in response to a command, e.g., if another sensor 106 has detected motion.

The camera 108 can collect images, e.g., snapshots, that potentially include a representation of the person 118 in the images. The camera 108 can include a snapshot analysis engine 110 and memory 112. In some implementations, the camera 108 is connected to the snapshot analysis engine 110 and the memory 112, e.g., these components are not a part of the camera 108.

While the camera 108 is still recording, e.g., capturing, a video sequence, the snapshot analysis engine 110 can analyze the images that have already been captured. The snapshot analysis engine 110 can include a machine learning model, e.g., an object classification model, that predicts whether or not a snapshot includes a representation of a person or another entity of interest. For example, the video analysis system 104 can use computer vision and an object classifier to determine whether an object in a snapshot represents a person, an animal, a vehicle, a robot, a plant, or something else.

In some implementations, the snapshot analysis engine 110 determines a snapshot likelihood score, which measures the likelihood that the snapshot includes a representation of a person or another entity of interest. An entity of interest can be an entity such as a person, a robot, an animal, or a vehicle, that is likely to approach within a threshold distance of the camera 108, that is likely to destroy the camera, or a combination of both. Although the examples described with reference to FIG. 1 refer to a person, the implementation can apply to an entity of interest in general or other types of entities of interest.

The camera 108 can be configured to send the snapshot to the video analysis system if the snapshot analysis engine 110 determines that the snapshot likely includes a representation of a person, e.g., the snapshot likelihood score satisfies a snapshot threshold. In some implementations, the camera 108 can be configured to only send the snapshot if the snapshot analysis engine 110 detects a representation of a person in the snapshot or a predetermined feature, e.g., a head or face of the detected person.

In some implementations, the camera 108 is configured to send the snapshot once the object is within the threshold distance D of the property. For instance, this can occur before the snapshot analysis system 110 has determined that the video sequence likely includes images that include a representation a person or another entity of interest. In this way, the camera 108 can reduce a risk that the camera 108 might be damaged if the camera waited to send the snapshot until the snapshot analysis system 110 determines that the video sequence likely includes images that include a representation of an entity of interest.

In some implementations, the camera 108 is configured to send a portion of the video sequence after the video analysis system 104 detects a representation of person 118. For example, the portion of the video sequence can be a relatively short video, e.g., one second or less, that includes at least one frame, as the snapshot, with the representation of the person 118. Before sending the snapshot to the video analysis system 104, the camera 108 can store the captured portion of the video sequence including the snapshot in memory 112.

In some home monitoring systems, there can be a delay between recording a video and uploading the video to the video analysis system 104, e.g., that includes a backend subsystem that maintains the video in memory. Various factors can contribute to this delay. For example, buffering, storing the data into memory 112, and preparing the video into subunits to send over a network all take finite periods of time included in the delay time, e.g., an inherent delay. In some implementations, the system introduces an additional delay so that more time elapses after detecting an entity before uploading a video sequence. This way, the system can be more likely to capture a video sequence of the entity's actions rather than just the entity approaching the property. As a result of the inherent delay and the additional delay, there is a window between when a person is first detected by a camera 108 and when the video analysis system 104 receives a video sequence including a representation of the person. During this window, if the camera is damaged, disconnected, e.g., from a network or power source, or both, e.g., by the person, and unable to upload the video, it is possible that the video analysis system 104 and the home monitoring system that includes the camera 108 will not have any data about the person.

To reduce the likelihood of this possibility, the camera 108 can be configured to send a snapshot from the video sequence as soon as the snapshot analysis engine 110 determines that the video sequence likely includes a representation of a person 118, e.g., immediately after the inherent delay for the currently captured video and not using the additional delay or given any delay for capture of any additional video. For example, the snapshot can be a single frame in the video sequence, and thus have a smaller data size than the overall video sequence. This can enable the camera 110 to upload the snapshot to the video analysis system 104 more quickly than uploading the entire video sequence. For instance, preparation of the snapshot can have less overhead, e.g., computational overhead, than preparation of the entire video sequence for transmission.

In some implementations, the threshold period of time is the shortest period of time it takes the camera 108 to prepare the video sequence for uploading. The camera 108 can begin the preparation while continuing to capture data for the video sequence or after capturing all data for the video sequence. In some implementations, the threshold period of time is on the order of seconds or minutes.

In some implementations, the minimum delay depends on the size of the video sequence. For example, a shorter video sequence can have a shorter delay. In this case, the threshold period of time when sending a portion of the video sequence can be less than the delay of the camera 108 for sending the entire video sequence.

In some implementations, the camera 108 sends a portion of the video sequence that has been collected between the time of detecting the person 118 and the time of sending the video sequence. For example, the snapshot analysis engine 110 can include rules for selecting what portions of video sequence are sent to the video analysis system 104. As an example, the rules can indicate that only portions of video including a representation of a person are sent to the video analysis system 104, that image quality of portions of the video that are sent to the video analysis system 104 satisfy image criteria, e.g., blurriness, brightness, and the like, or both.

The video analysis system 104 is configured to receive both snapshots and video sequences from the camera 108. For some instances in which an entity is detected by the camera 108, the video analysis system 104 might only receive a snapshot and not a corresponding video sequence. For instance, the video analysis system 104 is configured to determine, after a second threshold period of time from receiving a snapshot, whether the video analysis system 104 has received a video sequence from the camera 108.

In some implementations, the second threshold period of time that the video analysis system 104 waits before determining whether the video analysis system 104 has received the video sequence can be longer than the threshold period of time between the camera sending the snapshot in the video sequence, e.g., a first threshold period of time. For example, the first threshold period of time being shorter than the second threshold period of time allows for unexpected delays on the camera's ability to send the video sequence.

In some implementations, the second threshold period of time can be determined dynamically. For example, if the video analysis system 104 can detect network issues that can slow down the camera 108 sending video sequences over a network, the threshold period of time between receiving the snapshot from the camera 108 and the video analysis system 104 checking for receipt of the video sequence can increase. As a result, the video analysis system 104 can increase the duration of the second threshold time period.

The video analysis system 104 can include threshold criteria 114, which includes the second threshold period of time, and an analysis engine 116 for analyzing time signatures of the video analysis system 104 receiving snapshots and video sequences from the camera 108. For example, using the analysis engine 116, the video analysis system 104 can determine how much time passes after the video analysis system 104 receives the snapshot.

If the video analysis system 104 receives a video sequence from the camera 108 within the second threshold period of time after receiving the snapshot, it is more likely that the camera 108 is not damaged than if the video analysis system 104 had not received the video sequence within the threshold period of time. For example, if the camera 108 was able to send the video sequence to the video analysis system 104, the camera 108 likely still had connectivity capabilities. Conversely, if the camera 108 was not able to send the video sequence to the video analysis system 104, the reason for not being able to send the video sequence is possibly that the camera 108 is damaged.

The video analysis system 104 can be configured to, upon receipt of the video sequence, delete the snapshot. Deleting the snapshot after receiving the video sequence can reduce the total amount of memory used by the video analysis system 104, thereby reducing the computational demand.

In some implementations, the video analysis system 104 can be configured to, upon receipt of the video sequence, analyze the video sequence. As an example, the analysis engine 116 can analyze the received video sequence and determine that the image quality at the end of the video sequence is low and that the detected person 118 moved toward the camera 108 before the image quality reduced. In this example, the person 118 spray-painted the camera 108, and the camera 108 is damaged even though the camera 108 can still send video sequences to the video analysis system 104. Upon making such a determination, the decision engine 120 can determine an appropriate action for the property 102. For instance, the decision engine 120 can determine to trigger an alert.

The video analysis system 104 can be configured to, upon determining that the video analysis system 104 has not received the video sequence within the second threshold period of time of receiving the snapshot, determine whether the video analysis system 104 can communicate with the camera 108. For example, the video analysis system 104 can send a first signal to the camera 108, and the camera 108 can be configured to send a second signal back to the video analysis system 104 upon receipt of the first signal. In this example, if the video analysis system 104 does not receive a second signal, e.g., within a threshold period, the video analysis system 104 can determine that the video analysis system 14 and the camera 108 have lost connectivity.

In some implementations, the video analysis system 104 can be configured to only check for connectivity between the video analysis system 104 and the camera 108 if the video analysis system 104 has not received the video sequence within the second threshold period of time after receiving the snapshot. In this case, the video analysis system 104 can consume less power and use fewer computational resources by only checking for connectivity during certain circumstances.

In this specification, connectivity between the video analysis system 104 and camera 108 refers to the ability of the camera 108 to, e.g., wirelessly, send data to the video analysis system 104. In some implementations, it is possible that the camera 108 is unable to sends data to the video analysis system 104 and able to receive data from the video analysis system 104. In this case, there are still connectivity issues between the camera 108 and the video analysis system 104.

In some implementations, the video analysis system 104 can determine whether a backend system (not shown) received the video sequence. The video analysis system 104 can be included in or otherwise communicate with the backend system. For instance, the video analysis system 104 can be a subsystem implemented on one or more computers included in the backend system. In some examples, the backend can include a database, a server, or another appropriate type of computer that receives the video sequence. In these examples, the video analysis system 104 can be part of a separate system that determines whether the backend system received the video sequence.

The camera 108 and video analysis system 104 can communicate via one or more intermediary devices, e.g., a server. In some implementations, the server can check for connectivity between the video analysis system 104 and the camera 108 after receiving a signal from the video analysis system 104 indicating that the video analysis system 104 has not received the video sequence within the threshold period of time.

If the video analysis system 104, the server, e.g., as part of a backend system, or both can communicate with the camera 108, when neither the server nor the video analysis system 104 has received the video sequence within the threshold period of time after receiving the snapshot, the video analysis system 104 can determine that the camera 108 is likely malfunctioning for a reason other than being damaged by the detected person 118.

The video analysis system 104 can include a decision engine 120, which includes rules, or other appropriate code, based on the connectivity status between the video analysis system 104 and the camera 108. For example, if the video analysis system 104 receives the video sequence within the second threshold period of time after receiving the snapshot, the decision engine 120 can determine to proceed with normal operations. As another example, if the video analysis system 104, the server, or both can communicate with the camera 108 and the video analysis system 104 has not received the video sequence within the threshold period of time after receiving the snapshot, the decision engine 120 can determine to send an alert to a user device on the property 102 that the camera 108 is malfunctioning, the alert not mentioning the detected person 118.

In some implementations, when either one of or both of the video analysis system 104 or the server have determined that the video analysis system 104 cannot communicate with the camera 108, the video analysis system 104 can use the decision engine 120 to determine an action. For example, the decision engine 120 can include rules to trigger an alarm for the property 102 when either one of or both of the video analysis system 104 or the server have determined that the video analysis system 104 cannot communicate with the camera 108. Another appropriate action can include triggering a robot, e.g., a drone, to a location at the property to inspect the camera 108, an area of the property that includes the camera 108, or both.

In some implementations, when the video analysis system 104 receives the video sequence within the second threshold period of time of receiving the snapshot, the decision engine 120 can determine to send a notification to a user device on the property 102. The notification can include the snapshot with the representation of the person 118, other appropriate data, or a combination of both.

The video analysis system 104 is an example of a system implemented as computer programs on one or more computers in one or more locations, in which the systems, components, and techniques described in this specification are implemented. The sensors 106 can include personal computers, mobile communication devices, and other devices that can send and receive data over a network. The network (not shown), such as a local area network (“LAN”), wide area network (“WAN”), the Internet, or a combination thereof, connects the camera 108, video analysis system 104, the server. The video analysis system 104 can use a single computer or multiple computers operating in conjunction with one another, including, for example, a set of remote computers deployed as a cloud computing service.

The video analysis system 104, the camera 108, or both, can include several different functional components, which include one or more data processing apparatuses, can be implemented in code, or a combination of both. For instance, the components can include one or more data processors and instructions that cause the one or more data processors to perform the operations discussed herein. These components can include the analysis engine 116 and the decision engine 120 in the video analysis system 104 and the snapshot analysis engine 110 in the camera 108.

The various functional components of the sensors 106 and the video analysis system 104 can be installed on one or more computers as separate functional components or as different modules of a same functional component. For example, the components of the camera 108 and video analysis system 104 can be implemented as computer programs installed on one or more computers in one or more locations that are coupled to each through a network. In cloud-based systems for example, these components can be implemented by individual computing nodes of a distributed computing system.

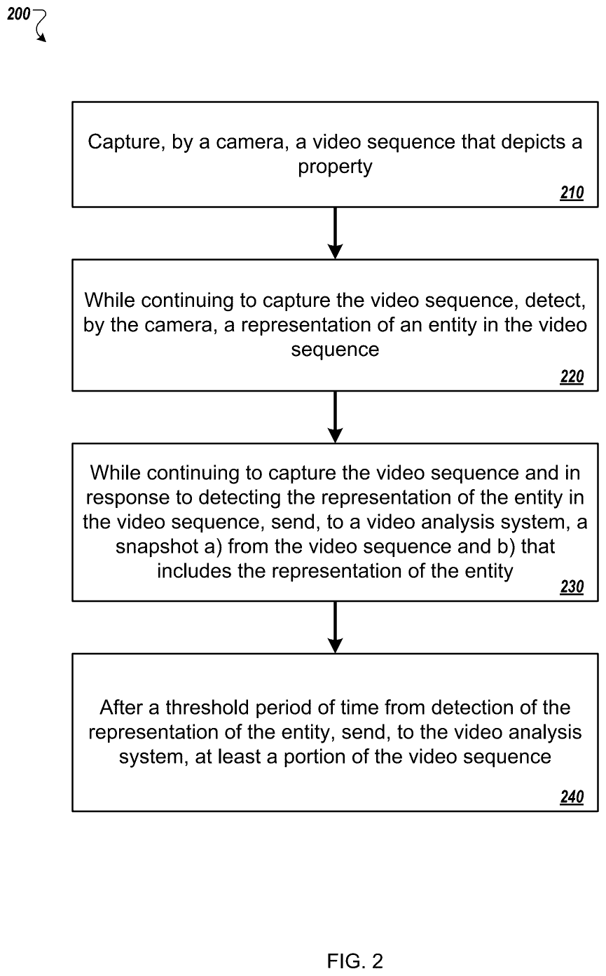

FIG. 2 is a flow diagram of a process 200 for sending a video sequence to a video analysis system. For example, the process 200 can be performed by the camera 108 from the environment 100.

A camera captures a video sequence that depicts a property, e.g., property 102 (210). For example, one or more cameras on the property can be configured to continuously capture and store, e.g., record, different views around the property.

While continuing to capture the video sequence, the camera detects a representation of an entity in the video sequence (220). For example, while already capturing a video sequence, a person 118 can enter the frame of the camera. The camera can include a snapshot analysis engine 110, which can detect representations of entities, e.g., moving entities, such as people, animals, robots, and vehicles. By recognizing the presence of an entity, the snapshot analysis engine 110 detects the representation of the entity.

The camera can capture video at any appropriate time. In some implementations, capturing the video sequence begins at about the same time the camera detects an entity. For example, the camera can be in communication with a different sensor that detects the entity, e.g., a motion sensor, and sends instructions to the camera to begin recording in response to detecting the entity. In some implementations, the camera 108 has a rotating buffer in memory that stores the last few seconds of captured video. For example, when detecting an entity, the camera 108 can maintain the video sequence already in the buffer and then store newly captured data for the video sequence to memory including a representation of the entity. As a result, the video sequence maintained in memory can feature a depiction of the entity near the middle of the video sequence instead of at the beginning of the video sequence.

While continuing to capture the video sequence and in response to detecting the representation of the entity in the video sequence, the camera sends, to a video analysis system, a snapshot (230). The snapshot is from the video sequence and includes the representation of the entity. In some implementations, the camera 108 uses the snapshot analysis engine 110 to select which snapshot from the video sequence to send. For example, the snapshot analysis engine 110 can select the snapshot using criteria for image quality, a first available snapshot for which an amount of the entity included in the snapshot satisfies a threshold, or a combination of both.

The snapshot can be any appropriate type of snapshot, e.g., a single image or multiple images. In some implementations, as a snapshot, the camera sends a short portion of video sequence, e.g., a video sequence lasting less than one second. The camera 108 can select the portion of the video sequence using one or more duration criteria that define requirements for the snapshot, e.g., a maximum duration for the portion. In some implementations, the camera will only send the snapshot to the video analysis system in response to detecting the representation of the entity.

After a threshold period of time from detection of the representation of the entity, the camera sends, to the video analysis system, at least a portion of the video sequence (240). For example, the camera can use the snapshot analysis engine 110 to select the portion of the video sequence to send, e.g., only portions including the representation of the entity.

In some implementations, the process 300 can include additional operations, fewer operations, or some of the operations can be divided into multiple operations. For example, the process 200 need not include operation 240. For instance, although the camera 108 would normally send the portion of the video sequence, when the camera 108 is damaged, loses a connection with the video analysis system, or a combination of both, the process 200 would not include step 240, e.g., because the camera would be unable to perform this operation.

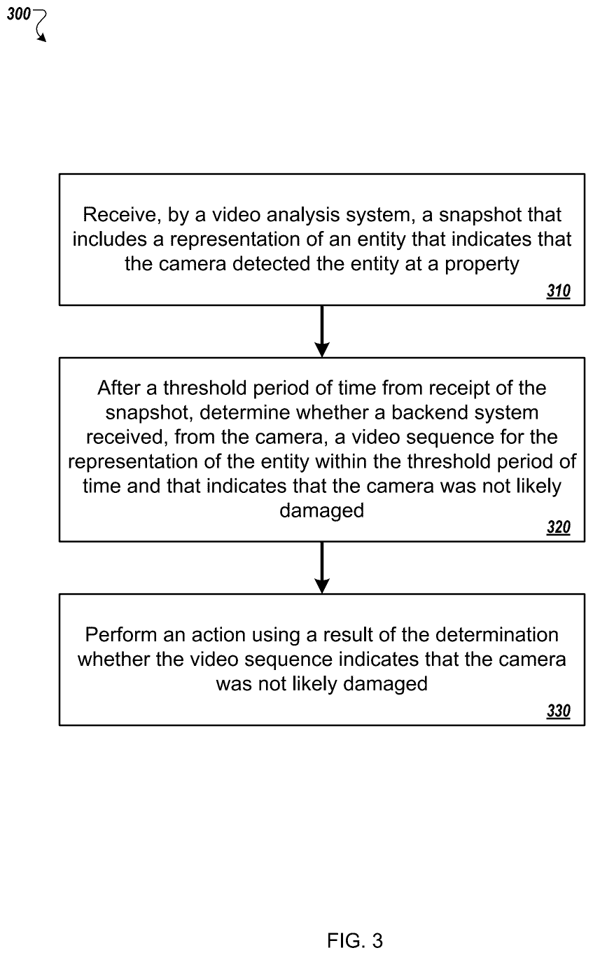

FIG. 3 is a flow diagram of a process 300 for performing an action based on receipt of a video sequence within a threshold period of time. For example, the process 300 can be performed by the video analysis system 104 from the environment 100.

The video analysis system receives a snapshot that includes a representation of an entity that indicates that the camera detected the entity at a property (310). The snapshot was captured by a camera.

After a threshold period of time from receipt of the snapshot, the video analysis system determines whether a backend system received, from the camera, a video sequence for the representation of the entity within a threshold period of time (320). The backend system can be any appropriate system, e.g., that includes the video analysis system or otherwise communicates with the video analysis system. For instance, the backend system can be a database that the video analysis system accesses to determine whether the database received the video sequence.

The video sequence being received within a threshold period of time indicates that the camera was not likely damaged. In some implementations, the video analysis system 104 determines whether the camera 108 has sent the video sequence directly to the video analysis system 104, or a backend system, within the threshold period of time.

In some implementations, step 320 includes determining threshold criteria 114, e.g., determining a threshold period of time based on network conditions for the camera, the backend system, the video analysis system 104, or a combination of these; user preferences; or a combination of both.

The video analysis system performs an action using a result of the determination whether the video sequence indicates that the camera was not likely damaged (330). For example, if the video analysis system 104 determines that the video sequence indicates that the camera was not likely damaged, the video analysis system 104 can delete the received snapshot. In some examples, if the video analysis system 104 determines that the video sequence indicates that the camera was likely damaged, e.g., the video sequence was not received within the threshold period of time, the video analysis system 104 can trigger an alarm at the property.

In some implementations, the process 300 can include additional operations, fewer operations, or some of the operations can be divided into multiple operations. For example, between steps 320 and 330, a decision engine 120 of the video analysis system 104 can determine the action to be performed.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

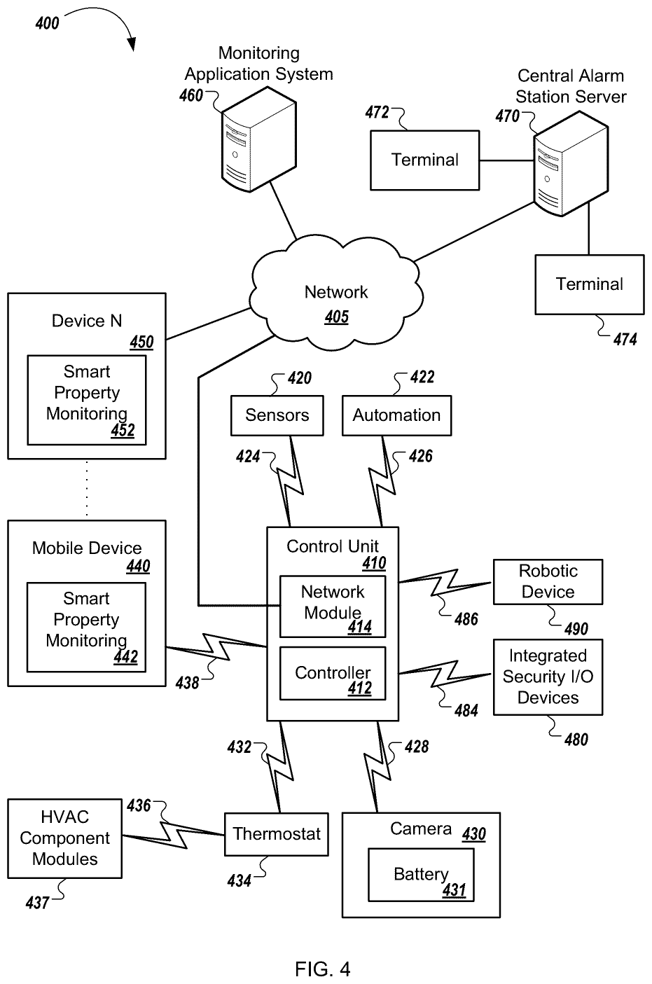

FIG. 4 is a diagram illustrating an example of an environment 400, e.g., for monitoring a property. The property can be any appropriate type of property, such as a home, a business, or a combination of both. The environment 400 includes a network 405, a control unit 410, one or more devices 440 and 450, a monitoring system 460, a central alarm station server 470, or a combination of two or more of these. In some examples, the network 405 facilitates communications between two or more of the control unit 410, the one or more devices 440 and 450, the monitoring system 460, and the central alarm station server 470.

The network 405 is configured to enable exchange of electronic communications between devices connected to the network 405. For example, the network 405 can be configured to enable exchange of electronic communications between the control unit 410, the one or more devices 440 and 450, the monitoring system 460, and the central alarm station server 470. The network 405 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 405 can include multiple networks or subnetworks, each of which can include, for example, a wired or wireless data pathway. The network 405 can include a circuit-switched network, a packet-switched data network, or any other network able to carry electronic communications (e.g., data or voice communications). For example, the network 405 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 405 can include one or more networks that include wireless data channels and wireless voice channels. The network 405 can be a broadband network.

The control unit 410 includes a controller 412 and a network module 414. The controller 412 is configured to control a control unit monitoring system, e.g., a control unit system, that includes the control unit 410. In some examples, the controller 412 can include one or more processors or other control circuitry configured to execute instructions of a program that controls operation of a control unit system. In these examples, the controller 412 can be configured to receive input from sensors, or other devices included in the control unit system and control operations of devices at the property, e.g., speakers, displays, lights, doors, other appropriate devices, or a combination of these. For example, the controller 412 can be configured to control operation of the network module 414 included in the control unit 410.

The network module 414 is a communication device configured to exchange communications over the network 405. The network module 414 can be a wireless communication module configured to exchange wireless, wired, or a combination of both, communications over the network 405. For example, the network module 414 can be a wireless communication device configured to exchange communications over a wireless data channel and a wireless voice channel. In some examples, the network module 414 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 414 can be a wired communication module configured to exchange communications over the network 405 using a wired connection. For instance, the network module 414 can be a modem, a network interface card, or another type of network interface device. The network module 414 can be an Ethernet network card configured to enable the control unit 410 to communicate over a local area network, the Internet, or a combination of both. The network module 414 can be a voice band modem configured to enable the alarm panel to communicate over the telephone lines of Plain Old Telephone Systems (“POTS”).

The control unit system that includes the control unit 410 can include one or more sensors 420. For example, the environment 400 can include multiple sensors 420. The sensors 420 can include a lock sensor, a contact sensor, a motion sensor, a camera (e.g., a camera 430), a flow meter, any other type of sensor included in a control unit system, or a combination of two or more of these. The sensors 420 can include an environmental sensor, such as a temperature sensor, a water sensor, a rain sensor, a wind sensor, a light sensor, a smoke detector, a carbon monoxide detector, or an air quality sensor, to name a few additional examples. The sensors 420 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heart-rate, respiration rate, sugar or glucose level, bodily temperature, motion data, or a combination of these. The sensors 420 can include a radio-frequency identification (“RFID”) sensor that identifies a particular article that includes a pre-assigned RFID tag.

The control unit 410 can communicates with a module 422 and a camera 430 to perform monitoring. The module 422 is connected to one or more devices that enable property automation, e.g., home or business automation. For instance, the module 422 can connect to, and be configured to control operation of, one or more lighting systems. The module 422 can connect to, and be configured to control operation of, one or more electronic locks, e.g., control Z-Wave locks using wireless communications in the Z-Wave protocol. In some examples, the module 422 can connect to, and be configured to control operation of, one or more appliances. The module 422 can include multiple sub-modules that are each specific to a type of device being controlled in an automated manner. The module 422 can control the one or more devices using commands received from the control unit 410. For instance, the module 422 can receive a command from the control unit 410, which command was sent using data captured by the camera 430 that depicts an area. In response, the module 422 can cause a lighting system to illuminate an area to provide better lighting in the area, and a higher likelihood that the camera 430 can capture a subsequent image of the area that depicts more accurate data of the area.

The camera 430 can be an image camera or other type of optical sensing device configured to capture one or more images. For instance, the camera 430 can be configured to capture images of an area within a property monitored by the control unit 410. The camera 430 can be configured to capture single, static images of the area; video of the area, e.g., a sequence of images; or a combination of both. The camera 430 can be controlled using commands received from the control unit 410 or another device in the property monitoring system, e.g., a device 450.

The camera 430 can be triggered using any appropriate techniques, can capture images continuous, or a combination of both. For instance, a Passive Infra-Red (“PIR”) motion sensor can be built into the camera 430 and used to trigger the camera 430 to capture one or more images when motion is detected. The camera 430 can include a microwave motion sensor built into the camera which sensor is used to trigger the camera 430 to capture one or more images when motion is detected. The camera 430 can have a “normally open” or “normally closed” digital input that can trigger capture of one or more images when external sensors detect motion or other events. The external sensors can include another sensor from the sensors 420, PIR, or door or window sensors, to name a few examples. In some implementations, the camera 430 receives a command to capture an image, e.g., when external devices detect motion or another potential alarm event or in response to a request from a device. The camera 430 can receive the command from the controller 412, directly from one of the sensors 420, or a combination of both.

In some examples, the camera 430 triggers integrated or external illuminators to improve image quality when the scene is dark. Some examples of illuminators can include Infra-Red, Z-wave controlled “white” lights, lights controlled by the module 422, or a combination of these. An integrated or separate light sensor can be used to determine if illumination is desired and can result in increased image quality.

The camera 430 can be programmed with any combination of time schedule, day schedule, system “arming state”, other variables, or a combination of these, to determine whether images should be captured when one or more triggers occur. The camera 430 can enter a low-power mode when not capturing images. In this case, the camera 430 can wake periodically to check for inbound messages from the controller 412 or another device. The camera 430 can be powered by internal, replaceable batteries, e.g., if located remotely from the control unit 410. The camera 430 can employ a small solar cell to recharge the battery when light is available. The camera 430 can be powered by a wired power supply, e.g., the controller's 412 power supply if the camera 430 is co-located with the controller 412.

In some implementations, the camera 430 communicates directly with the monitoring system 460 over the network 405. In these implementations, image data captured by the camera 430 need not pass through the control unit 410. The camera 430 can receive commands related to operation from the monitoring system 460, provide images to the monitoring system 460, or a combination of both.

The environment 400 can include one or more thermostats 434, e.g., to perform dynamic environmental control at the property. The thermostat 434 is configured to monitor temperature of the property, energy consumption of a heating, ventilation, and air conditioning (“HVAC”) system associated with the thermostat 434, or both. In some examples, the thermostat 434 is configured to provide control of environmental (e.g., temperature) settings. In some implementations, the thermostat 434 can additionally or alternatively receive data relating to activity at a property; environmental data at a property, e.g., at various locations indoors or outdoors or both at the property; or a combination of both. The thermostat 434 can measure or estimate energy consumption of the HVAC system associated with the thermostat. The thermostat 434 can estimate energy consumption, for example, using data that indicates usage of one or more components of the HVAC system associated with the thermostat 434. The thermostat 434 can communicate various data, e.g., temperature, energy, or both, with the control unit 410. In some examples, the thermostat 434 can control the environmental, e.g., temperature, settings in response to commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In some examples, the control unit 410 can be a gateway device that communicates with the dynamically programmable thermostat 434. In some implementations, the thermostat 434 is controlled via one or more modules 422.

The environment 400 can include the HVAC system or otherwise be connected to the HVAC system. For instance, the environment 400 can include one or more HVAC modules 437. The HVAC modules 437 can be connected to one or more components of the HVAC system associated with a property. A module 437 can be configured to capture sensor data from, control operation of, or both, corresponding components of the HVAC system. In some implementations, the module 437 is configured to monitor energy consumption of an HVAC system component, for example, by directly measuring the energy consumption of the HVAC system components or by estimating the energy usage of the one or more HVAC system components by detecting usage of components of the HVAC system. The module 437 can communicate energy monitoring information, the state of the HVAC system components, or both, to the thermostat 434. The module 437 can control the one or more components of the HVAC system in response to receipt of commands received from the thermostat 434.

In some examples, the environment 400 includes one or more robotic devices 490. The robotic devices 490 can be any type of robots that are capable of moving, such as an aerial drone, a land-based robot, or a combination of both. The robotic devices 490 can taking actions, such as capture sensor data or other actions that assist in security monitoring, property automation, or a combination of both. For example, the robotic devices 490 can include robots capable of moving throughout a property using automated navigation control technology, user input control provided by a user, or a combination of both. The robotic devices 490 can fly, roll, walk, or otherwise move about the property. The robotic devices 490 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 490 can be robotic devices 490 that are intended for other purposes and merely associated with the environment 400 for use in appropriate circumstances. For instance, a robotic vacuum cleaner device can be associated with the environment 400 as one of the robotic devices 490 and can be controlled to take action responsive to monitoring system events.

In some examples, the robotic devices 490 automatically navigate within a property. In these examples, the robotic devices 490 include sensors and control processors that guide movement of the robotic devices 490 within the property. For instance, the robotic devices 490 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 490 can include control processors that process output from the various sensors and control the robotic devices 490 to move along a path that reaches the desired destination, avoids obstacles, or a combination of both. In this regard, the control processors detect walls or other obstacles in the property and guide movement of the robotic devices 490 in a manner that avoids the walls and other obstacles.

In some implementations, the robotic devices 490 can store data that describes attributes of the property. For instance, the robotic devices 490 can store a floorplan, a three- dimensional model of the property, or a combination of both, that enable the robotic devices 490 to navigate the property. During initial configuration, the robotic devices 490 can receive the data describing attributes of the property, determine a frame of reference to the data (e.g., a property or reference location in the property), and navigate the property using the frame of reference and the data describing attributes of the property. In some examples, initial configuration of the robotic devices 490 can include learning one or more navigation patterns in which a user provides input to control the robotic devices 490 to perform a specific navigation action (e.g., fly to an upstairs bedroom and spin around while capturing video and then return to a property charging base). In this regard, the robotic devices 490 can learn and store the navigation patterns such that the robotic devices 490 can automatically repeat the specific navigation actions upon a later request.

In some examples, the robotic devices 490 can include data capture devices. In these examples, the robotic devices 490 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 490 to take and store a biometric sample that can be used to identify the person (e.g., a biometric sample with DNA that can be used for DNA testing).

In some implementations, the robotic devices 490 can include output devices. In these implementations, the robotic devices 490 can include one or more displays, one or more speakers, any other type of output devices that allow the robotic devices 490 to communicate information, e.g., to a nearby user or another type of person, or a combination of these.

The robotic devices 490 can include a communication module that enables the robotic devices 490 to communicate with the control unit 410, each other, other devices, or a combination of these. The communication module can be a wireless communication module that allows the robotic devices 490 to communicate wirelessly. For instance, the communication module can be a Wi-Fi module that enables the robotic devices 490 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 490 to communicate with other devices, e.g., in or off the property. In some implementations, the robotic devices 490 can communicate with each other or with other devices of the environment 400 through the network 405.

The robotic devices 490 can include processor and storage capabilities. The robotic devices 490 can include any one or more suitable processing devices that enable the robotic devices 490 to execute instructions, operate applications, perform the actions described throughout this specification, or a combination of these. In some examples, the robotic devices 490 can include solid-state electronic storage that enables the robotic devices 490 to store applications, configuration data, collected sensor data, any other type of information available to the robotic devices 490, or a combination of two or more of these.

The robotic devices 490 can process captured data locally, provide captured data to one or more other devices for processing, e.g., the control unit 410 or the monitoring system 460, or a combination of both. For instance, the robotic device 490 can provide the images to the control unit 410 for processing. In some examples, the robotic device 490 can process the images to determine an identification of the items.

One or more of the robotic devices 490 can be associated with one or more charging stations. The charging stations can be located at a predefined home base or reference location in the property. The robotic devices 490 can be configured to navigate to one of the charging stations after completion of one or more tasks needed to be performed, e.g., for the environment 400. For instance, after completion of a monitoring operation or upon instruction by the control unit 410, a robotic device 490 can be configured to automatically fly to and connect with, e.g., land on, one of the charging stations. In this regard, a robotic device 490 can automatically recharge one or more batteries included in the robotic device 490 so that the robotic device 490 is less likely to need recharging when the environment 400 requires use of the robotic device 490, e.g., absent other concerns for the robotic device 490.

The charging stations can be contact-based charging stations, wireless charging stations, or a combination of both. For contact-based charging stations, the robotic devices 490 can have readily accessible points of contact to which a robotic device 490 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 490 can include a cover that opens to expose the electronic contact when the robotic device is charging and closes to cover and insulate the electronic contact when the robotic device 490 is in operation.

For wireless charging stations, the robotic devices 490 can charge through a wireless exchange of power. In these instances, a robotic device 490 needs only position itself closely enough to a wireless charging station for the wireless exchange of power to occur. In this regard, the positioning needed to land at a predefined home base or reference location in the property can be less precise than with a contact-based charging station. Based on the robotic devices 490 landing at a wireless charging station, the wireless charging station can output a wireless signal that the robotic device 490 receives and converts to a power signal that charges a battery maintained on the robotic device 490. As described in this specification, a robotic device 490 landing or coupling with a charging station can include a robotic device 490 positioning itself within a threshold distance of a wireless charging station such that the robotic device 490 is able to charge its battery.

In some implementations, one or more of the robotic devices 490 has an assigned charging station. In these implementations, the number of robotic devices 490 can equal the number of charging stations. In these implementations, the robotic devices 490 can always navigate to the specific charging station assigned to that robotic device 490. For instance, a first robotic device can always use a first charging station and a second robotic device can always use a second charging station.

In some examples, the robotic devices 490 can share charging stations. For instance, the robotic devices 490 can use one or more community charging stations that are capable of charging multiple robotic devices 490, e.g., substantially concurrently or separately or a combination of both at different times. The community charging station can be configured to charge multiple robotic devices 490 at substantially the same time, e.g., the community charging station can begin charging a first robotic device and then, while charging the first robotic device, begin charging a second robotic device five minutes later. The community charging station can be configured to charge multiple robotic devices 490 in serial such that the multiple robotic devices 490 take turns charging and, when fully charged, return to a predefined home base or reference location or another location in the property that is not associated with a charging station. The number of community charging stations can be less than the number of robotic devices 490.

In some instances, the charging stations might not be assigned to specific robotic devices 490 and can be capable of charging any of the robotic devices 490. In this regard, the robotic devices 490 can use any suitable, unoccupied charging station when not in use, e.g., when not performing an operation for the environment 400. For instance, when one of the robotic devices 490 has completed an operation or is in need of battery charge, the control unit 410 can reference a stored table of the occupancy status of each charging station and instructs the robotic device to navigate to the nearest charging station that has at least one unoccupied charger.

The environment 400 can include one or more integrated security devices 480. The one or more integrated security devices can include any type of device used to provide alerts based on received sensor data. For instance, the one or more control units 410 can provide one or more alerts to the one or more integrated security input/output devices 480. In some examples, the one or more control units 410 can receive sensor data from the sensors 420 and determine whether to provide an alert, or a message to cause presentation of an alert, to the one or more integrated security input/output devices 480.

The sensors 420, the module 422, the camera 430, the thermostat 434, and the integrated security devices 480 can communicate with the controller 412 over communication links 424, 426, 428, 432, 438, 484, and 486. The communication links 424, 426, 428, 432, 438, 484, and 486 can be a wired or wireless data pathway configured to transmit signals between any combination of the sensors 420, the module 422, the camera 430, the thermostat 434, the robotic devices 490, the integrated security devices 480, or the controller 412. The sensors 420, the module 422, the camera 430, the thermostat 434, the robotic devices 490, and the integrated security devices 480 can continuously transmit sensed values to the controller 412, periodically transmit sensed values to the controller 412, or transmit sensed values to the controller 412 in response to a change in a sensed value, a request, or both. In some implementations, the robotic devices 490 can communicate with the monitoring system 460 over network 405. The robotic devices 490 can connect and communicate with the monitoring system 460 using a Wi-Fi or a cellular connection or any other appropriate type of connection.

The communication links 424, 426, 428, 432, 438, 484, and 486 can include any appropriate type of network, such as a local network. The sensors 420, the module 422, the camera 430, the thermostat 434, the robotic devices 490 and the integrated security devices 480, and the controller 412 can exchange data and commands over the network.

The monitoring system 460 can include one or more electronic devices, e.g., one or more computers. The monitoring system 460 is configured to provide monitoring services by exchanging electronic communications with the control unit 410, the one or more devices 440 and 450, the central alarm station server 470, or a combination of these, over the network 405. For example, the monitoring system 460 can be configured to monitor events (e.g., alarm events) generated by the control unit 410. In this example, the monitoring system 460 can exchange electronic communications with the network module 414 included in the control unit 410 to receive information regarding events (e.g., alerts) detected by the control unit 410. The monitoring system 460 can receive information regarding events (e.g., alerts) from the one or more devices 440 and 450.

In some implementations, the monitoring system 460 might be configured to provide one or more services other than monitoring services. In these implementations, the monitoring system 460 might perform one or more operations described in this specification without providing any monitoring services, e.g., the monitoring system 460 might not be a monitoring system as described in the example shown in FIG. 4.

In some examples, the monitoring system 460 can route alert data received from the network module 414 or the one or more devices 440 and 450 to the central alarm station server 470. For example, the monitoring system 460 can transmit the alert data to the central alarm station server 470 over the network 405.

The monitoring system 460 can store sensor and image data received from the environment 400 and perform analysis of sensor and image data received from the environment 400. Based on the analysis, the monitoring system 460 can communicate with and control aspects of the control unit 410 or the one or more devices 440 and 450.

The monitoring system 460 can provide various monitoring services to the environment 400. For example, the monitoring system 460 can analyze the sensor, image, and other data to determine an activity pattern of a person of the property monitored by the environment 400. In some implementations, the monitoring system 460 can analyze the data for alarm conditions or can determine and perform actions at the property by issuing commands to one or more components of the environment 400, possibly through the control unit 410.

The central alarm station server 470 is an electronic device, or multiple electronic devices, configured to provide alarm monitoring service by exchanging communications with the control unit 410, the one or more mobile devices 440 and 450, the monitoring system 460, or a combination of these, over the network 405. For example, the central alarm station server 470 can be configured to monitor alerting events generated by the control unit 410. In this example, the central alarm station server 470 can exchange communications with the network module 414 included in the control unit 410 to receive information regarding alerting events detected by the control unit 410. The central alarm station server 470 can receive information regarding alerting events from the one or more mobile devices 440 and 450, the monitoring system 460, or both.

The central alarm station server 470 is connected to multiple terminals 472 and 474. The terminals 472 and 474 can be used by operators to process alerting events. For example, the central alarm station server 470, e.g., as part of a first responder system, can route alerting data to the terminals 472 and 474 to enable an operator to process the alerting data. The terminals 472 and 474 can include general-purpose computers (e.g., desktop personal computers, workstations, or laptop computers) that are configured to receive alerting data from a computer in the central alarm station server 470 and render a display of information using the alerting data.

For instance, the controller 412 can control the network module 414 to transmit, to the central alarm station server 470, alerting data indicating that a sensor 420 detected motion from a motion sensor via the sensors 420. The central alarm station server 470 can receive the alerting data and route the alerting data to the terminal 472 for processing by an operator associated with the terminal 472. The terminal 472 can render a display to the operator that includes information associated with the alerting event (e.g., the lock sensor data, the motion sensor data, the contact sensor data, etc.) and the operator can handle the alerting event based on the displayed information. In some implementations, the terminals 472 and 474 can be mobile devices or devices designed for a specific function. Although FIG. 4 illustrates two terminals for brevity, actual implementations can include more (and, perhaps, many more) terminals.

The one or more devices 440 and 450 are devices that can present content, e.g., host and display user interfaces, audio data, or both. For instance, the mobile device 440 is a mobile device that hosts or runs one or more native applications (e.g., the smart property application 442). The mobile device 440 can be a cellular phone or a non-cellular locally networked device with a display. The mobile device 440 can include a cell phone, a smart phone, a tablet PC, a personal digital assistant (“PDA”), or any other portable device configured to communicate over a network and present information. The mobile device 440 can perform functions unrelated to the monitoring system, such as placing personal telephone calls, playing music, playing video, displaying pictures, browsing the Internet, and maintaining an electronic calendar.

The mobile device 440 can include a smart property application 442. The smart property application 442 refers to a software/firmware program running on the corresponding mobile device that enables the user interface and features described throughout. The mobile device 440 can load or install the smart property application 442 using data received over a network or data received from local media. The smart property application 442 enables the mobile device 440 to receive and process image and sensor data from the monitoring system 460.

The device 450 can be a general-purpose computer (e.g., a desktop personal computer, a workstation, or a laptop computer) that is configured to communicate with the monitoring system 460, the control unit 410, or both, over the network 405. The device 450 can be configured to display a smart property user interface 452 that is generated by the device 450 or generated by the monitoring system 460. For example, the device 450 can be configured to display a user interface (e.g., a web page) generated using data provided by the monitoring system 460 that enables a user to perceive images captured by the camera 430, reports related to the monitoring system, or both. Although FIG. 4 illustrates two devices for brevity, actual implementations can include more (and, perhaps, many more) or fewer devices.

In some implementations, the one or more devices 440 and 450 communicate with and receive data from the control unit 410 using the communication link 438. For instance, the one or more devices 440 and 450 can communicate with the control unit 410 using various wireless protocols, or wired protocols such as Ethernet and USB, to connect the one or more devices 440 and 450 to the control unit 410, e.g., local security and automation equipment. The one or more devices 440 and 450 can use a local network, a wide area network, or a combination of both, to communicate with other components in the environment 400. The one or more devices 440 and 450 can connect locally to the sensors and other devices in the environment 400.

Although the one or more devices 440 and 450 are shown as communicating with the control unit 410, the one or more devices 440 and 450 can communicate directly with the sensors and other devices controlled by the control unit 410. In some implementations, the one or more devices 440 and 450 replace the control unit 410 and perform one or more of the functions of the control unit 410 for local monitoring and long range, offsite, or both, communication.

In some implementations, the one or more devices 440 and 450 receive monitoring system data captured by the control unit 410 through the network 405. The one or more devices 440 and 450 can receive the data from the control unit 410 through the network 405, the monitoring system 460 can relay data received from the control unit 410 to the one or more devices 440 and 450 through the network 405, or a combination of both. In this regard, the monitoring system 460 can facilitate communication between the one or more devices 440 and 450 and various other components in the environment 400.

In some implementations, the one or more devices 440 and 450 can be configured to switch whether the one or more devices 440 and 450 communicate with the control unit 410 directly (e.g., through communication link 438) or through the monitoring system 460 (e.g., through network 405) based on a location of the one or more devices 440 and 450. For instance, when the one or more devices 440 and 450 are located close to, e.g., within a threshold distance of, the control unit 410 and in range to communicate directly with the control unit 410, the one or more devices 440 and 450 use direct communication. When the one or more devices 440 and 450 are located far from, e.g., outside the threshold distance of, the control unit 410 and not in range to communicate directly with the control unit 410, the one or more devices 440 and 450 use communication through the monitoring system 460.

Although the one or more devices 440 and 450 are shown as being connected to the network 405, in some implementations, the one or more devices 440 and 450 are not connected to the network 405. In these implementations, the one or more devices 440 and 450 communicate directly with one or more of the monitoring system components and no network (e.g., Internet) connection or reliance on remote servers is needed.

In some implementations, the one or more devices 440 and 450 are used in conjunction with only local sensors and/or local devices in a house. In these implementations, the environment 400 includes the one or more devices 440 and 450, the sensors 420, the module 422, the camera 430, and the robotic devices 490. The one or more devices 440 and 450 receive data directly from the sensors 420, the module 422, the camera 430, the robotic devices 490, or a combination of these, and send data directly to the sensors 420, the module 422, the camera 430, the robotic devices 490, or a combination of these. The one or more devices 440 and 450 can provide the appropriate interface, processing, or both, to provide visual surveillance and reporting using data received from the various other components.

In some implementations, the environment 400 includes network 405 and the sensors 420, the module 422, the camera 430, the thermostat 434, and the robotic devices 490 are configured to communicate sensor and image data to the one or more devices 440 and 450 over network 405. In some implementations, the sensors 420, the module 422, the camera 430, the thermostat 434, and the robotic devices 490 are programmed, e.g., intelligent enough, to change the communication pathway from a direct local pathway when the one or more devices 440 and 450 are in close physical proximity to the sensors 420, the module 422, the camera 430, the thermostat 434, the robotic devices 490, or a combination of these, to a pathway over network 405 when the one or more devices 440 and 450 are farther from the sensors 420, the module 422, the camera 430, the thermostat 434, the robotic devices 490, or a combination of these.

In some examples, the monitoring system 460 leverages GPS information from the one or more devices 440 and 450 to determine whether the one or more devices 440 and 450 are close enough to the sensors 420, the module 422, the camera 430, the thermostat 434, the robotic devices 490, or a combination of these, to use the direct local pathway or whether the one or more devices 440 and 450 are far enough from the sensors 420, the module 422, the camera 430, the thermostat 434, the robotic devices 490, or a combination of these, that the pathway over network 405 is required. In some examples, the monitoring system 460 leverages status communications (e.g., pinging) between the one or more devices 440 and 450 and the sensors 420, the module 422, the camera 430, the thermostat 434, the robotic devices 490, or a combination of these, to determine whether communication using the direct local pathway is possible. If communication using the direct local pathway is possible, the one or more devices 440 and 450 communicate with the sensors 420, the module 422, the camera 430, the thermostat 434, the robotic devices 490, or a combination of these, using the direct local pathway. If communication using the direct local pathway is not possible, the one or more devices 440 and 450 communicate with the sensors 420, the module 422, the camera 430, the thermostat 434, the robotic devices 490, or a combination of these, using the pathway over network 405.

In some implementations, the environment 400 provides people with access to images captured by the camera 430 to aid in decision-making. The environment 400 can transmit the images captured by the camera 430 over a network, e.g., a wireless WAN, to the devices 440 and 450. Because transmission over a network can be relatively expensive, the environment 400 can use several techniques to reduce costs while providing access to significant levels of useful visual information (e.g., compressing data, down-sampling data, sending data only over inexpensive LAN connections, or other techniques).

In some implementations, a state of the environment 400, one or more components in the environment 400, and other events sensed by a component in the environment 400 can be used to enable/disable video/image recording devices (e.g., the camera 430). In these implementations, the camera 430 can be set to capture images on a periodic basis when the alarm system is armed in an “away” state, set not to capture images when the alarm system is armed in a “stay” state or disarmed, or a combination of both. In some examples, the camera 430 can be triggered to begin capturing images when the control unit 410 detects an event, such as an alarm event, a door-opening event for a door that leads to an area within a field of view of the camera 430, or motion in the area within the field of view of the camera 430. In some implementations, the camera 430 can capture images continuously, but the captured images can be stored or transmitted over a network when needed.

Although FIG. 4 depicts the monitoring system 460 as remote from the control unit 410, in some examples the control unit 410 can be a component of the monitoring system 460. For instance, both the monitoring system 460 and the control unit 410 can be physically located at a property that includes the sensors 420 or at a location outside the property.

In some examples, some of the sensors 420, the robotic devices 490, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 410, the monitoring system 460, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A method comprising:
capturing, by a camera, a video sequence that depicts a property;
while continuing to capture the video sequence:
detecting, by the camera, a representation of an entity in the video sequence; and
in response to detecting the representation of the entity in the video sequence, sending, to a video analysis system, a snapshot a) from the video sequence and b) that includes the representation of the entity; and
after a threshold period of time from detection of the representation of the entity, sending, to the video analysis system, at least a portion of the video sequence.

2. The method of claim 1, wherein the camera sends the snapshot only in response to only detecting the representation of the entity.

3. The method of claim 1, wherein the portion of the video sequence includes the snapshot.

4. The method of claim 1, wherein sending the snapshot comprises sending the snapshot within a time period from detecting the representation of the entity in the video sequence that is less than a delay time period of the camera for sending data.

5. The method of claim 1, wherein a data size of the snapshot is less than a data size of the at least a portion of video sequence.

6. The method of claim 1, further comprising:
detecting that the entity is within a threshold distance of the property; and
in response to detecting that the entity is within the threshold distance of the property, sending the at least a portion of the video sequence to the video analysis system.

7. The method of claim 1, further comprising:
detecting, within the representation of the entity, a predetermined feature; and
in response to detecting the predetermined feature, sending the at least a portion of the video sequence to the video analysis system.

8. The method of claim 1, further comprising sending, to a backend server in communication with the video analysis system, the snapshot.

9. One or more computer storage media encoded with instructions that, when executed by one or more computers, cause the one or more computers to perform a method comprising:
capturing, by a camera, a video sequence that depicts a property;
while continuing to capture the video sequence:
detecting, by the camera, a representation of an entity in the video sequence; and
in response to detecting the representation of the entity in the video sequence, sending, to a video analysis system, a snapshot a) from the video sequence and b) that includes the representation of the entity; and
after a threshold period of time from detection of the representation of the entity, sending, to the video analysis system, at least a portion of the video sequence.

10. The computer storage media of claim 9, wherein the camera sends the snapshot only in response to only detecting the representation of the entity.

11. The computer storage media of claim 9, wherein the portion of the video sequence includes the snapshot.

12. The computer storage media of claim 9, wherein sending the snapshot comprises sending the snapshot within a time period from detecting the representation of the entity in the video sequence that is less than a delay time period of the camera for sending data.

13. The computer storage media of claim 9, wherein a data size of the snapshot is less than a data size of the at least a portion of video sequence.

14. The computer storage media of claim 9, wherein the method further comprises:
detecting that the entity is within a threshold distance of the property; and
in response to detecting that the entity is within the threshold distance of the property, sending the at least a portion of the video sequence to the video analysis system.

15. The computer storage media of claim 9, wherein the method further comprises:
detecting, within the representation of the entity, a predetermined feature; and
in response to detecting the predetermined feature, sending the at least a portion of the video sequence to the video analysis system.

16. The computer storage media of claim 9, wherein the method further comprises sending, to a backend server in communication with the video analysis system, the snapshot.

17. A system comprising one or more computers and one or more storage devices on which are stored instructions that are operable, when executed by the one or more computers, to cause the one or more computers to perform a method comprising:
capturing, by a camera, a video sequence that depicts a property;
while continuing to capture the video sequence:
detecting, by the camera, a representation of an entity in the video sequence; and
in response to detecting the representation of the entity in the video sequence, sending, to a video analysis system, a snapshot a) from the video sequence and b) that includes the representation of the entity; and
after a threshold period of time from detection of the representation of the entity,
sending, to the video analysis system, at least a portion of the video sequence.

18. The system of claim 17, wherein the camera sends the snapshot only in response to only detecting the representation of the entity.

19. The system of claim 17, wherein the portion of the video sequence includes the snapshot.

20. The system of claim 17, wherein sending the snapshot comprises sending the snapshot within a time period from detecting the representation of the entity in the video sequence that is less than a delay time period of the camera for sending data.
